(19) United States
(12) Patent Application Publication
(10) Pub. No.: US 2013/0302490 A1
(43) Pub. Date: Nov. 14, 2013

(54) System and Method for Treating Food Products to Reduce Pathogens and Other Contaminants

(71) Applicant: Justin D. James, Madera, CA (US)

(72) Inventor: Justin D. James, Madera, CA (US)

(21) Appl. No.: 13/467,006

(22) Filed: May 8, 2012

(51) Int. Cl. A23L 3/3445

(52) U.S. Cl. CPC A23L 3/3445
USPC 426/443; 99/516; 99/486

(57) ABSTRACT

A system and method for treating a food product to reduce the level of pathogens and/or enhance the food product generally comprises a conveying mechanism having a conveyor apparatus to convey raw food product placed in product compartments, a modular treatment unit that receives the product in the compartments, a treating apparatus that directs treated air to the food product and a controller for controlling the operation of the system. The system also has an input apparatus for placing the food product in the compartments, a by-pass apparatus for diverting untreated food product and a mechanism for discharging treated food products for further processing and/or packaging. The small product compartments provide for more efficient and effective treatment of food products, the system is substantially self-cleaning and the modular treatment units allow the user to easily and less expensively upgrade or modify the system for different food products and treatment processes.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to systems and methods for treating food products to reduce the transmission of pathogens and other contaminants to humans who consume the food products. In particular, the present invention relates to such systems and methods that are configured to be utilized to treat raw food products in a manner that isolates the raw food products from the final treated food products. Even more particularly, this invention relates to such systems and methods that allow for more specific operator control over the decontamination process.

B. Background

Raw food products that are harvested and prepared for consumption by people generally undergo one or more treatment processes prior to being made available to the consumer of the food product. Although some raw food products are harvested and then directly provided to the consumer, most raw food products are processed in a manner that reduces the level of pathogens and other contaminants that are associated with the food product so as to reduce the likelihood that persons will become sick or even die from eating a contaminated food product. As is well known, however, despite presently available processes for treating food products to at least reduce the level of pathogens and other contaminants, there are still incidents when people have become ill, sometimes very ill or even dying, from consuming contaminated food products. Examples of relatively recent pathogenic outbreaks associated with consuming food products include incidents of E. coli contamination of clover sprouts, romaine lettuce, hazelnuts and spinach, listeria contamination of cantaloupes and salmonella contamination of strawberries, spinach and tomatoes, some of which resulted in many people getting sick and a number of deaths. Food products which are generally the most susceptible to the transmission of pathogenic compounds include dry goods such as nuts and grains and harvested fruits and vegetables such as raisins, tomatoes, cantaloupes, lettuce and the like. Typically, the association of pathogens and like contaminants with particular food products is not an inherent aspect of growing or harvesting the food product. Instead, food products generally become contaminated with pathogens and other contaminants through contact with people, equipment, soil, water and the air.

Due to the potential for serious illness and death as a result of eating food products contaminated with pathogens or other contaminants, food products must be handled in a manner that reduces the likelihood that the pathogens and other contaminants will come in contact with the food products. In addition, many food products go through, often pursuant to requirements set forth in food safety regulations, a treatment system prior to the food product being packaged for consumption. As well known in the food industry, most pathogen contamination is associated with the consumption of raw or lightly processed food products. In addition, although the technology exists to totally eradicate any pathogens or other harmful contaminants that may be associated with a raw food product, for instance by exposing the food products to high temperatures or radiating the food product, those in the food industry know that such drastic treatment procedures are not practical for the vast majority of food products. In fact, food products such as lettuce, tomatoes, strawberries and the like are very difficult to treat due to the relative sensitive nature of the food products. Even food products which seem to be hardier, such as almonds and other nuts, can be visually damaged such that the value of the food product, and/or the percentage that is actually sent to the consumer, can be drastically reduced as a result of not being careful with how the food product is handled. As such, any type of food treatment system or method of reducing pathogens and other contaminants must be selected so as to achieve the desired treatment objectives in a manner that at least generally minimizes the likelihood of damaging or otherwise harming the food product.

In addition to food product treating systems and methods being selected so as to avoid or at least minimize any damage to the food products, it is well known that such systems and methods must also consider the practicalities with regard to treating particular food products. For instance, food products such as lettuce, tomatoes and the like are usually harvested and packed in the field without significant additional handling, which limits the availability to apply much of a treating system to the food products. Many food products are delivered to a packing house or other processing facility where they are treated to reduce the level of pathogens or other contaminants prior to being packaged for shipment. With regard to these food products, from a practical standpoint it is difficult for the operator of the processing facility to profitably justify spending significant amounts of time or money on treating the food products in light of the relatively low profit margin that currently exits for the typical processed food product. In addition, most such facilities already are arranged and have equipment setup to process the food item, thereby limiting the ability and/or desire to make any significant modifications to the facility. Another practical problem, is that a single facility may process one or more different types of food products and/or process the a single type of food product in different manners depending on the requirements of the purchaser or other food product customer and the desired end product. For example, almonds and other nuts may be processed in a single facility so as to be delivered to the customer in as a raw, roasted, coated or spiced product, each requiring different steps in the treating process to achieve the final product.

With regard to food processing facilities, governmental and industry standards generally require the final processing, such as the final culling and the packaging steps, of the treated product be separated from the handling of the raw product to reduce the likelihood that pathogens and/or other contaminants on the raw product will contaminate the clean processed product. Naturally, separation of the raw product from the processed product increases the cost of processing the food products as a result of the need for additional physical space, equipment and personnel. Such separation is generally achieved through the use of a clean room that is physically separated from the area of the facility where the raw food products are handled. In this type of setup, the raw food product is separated, cleaned and otherwise processed in an area outside the clean room and then delivered to the clean room for final culling and the packaging. Typically, much of the equipment in the clean room is made from stainless steel or other food grade materials so the surfaces thereof can be routinely cleaned and the people in the clean room are specially dressed and trained to prevent contamination of the clean food product. Despite the effort and cost to provide the clean room, the way the food products are presently handled in the facility makes it very difficult, if not nearly impossible, to ensure there is no cross-contamination between the raw and clean food products. As a result, governmental or industry standards and/or good business practice requires the processing facility, including the clean room, to be thoroughly cleaned on a regular or routine basis. As well known to those skilled in the art, cleaning the various processing equipment typically requires all or part of the facility to be at least substantially shut down for the time it takes to clean the equipment. Depending on the facility and level of cleanliness, this can take a significant amount of time, which results in loss of processing ability (in addition to the cost of cleaning itself). Some facilities are shut down for several days to achieve the desired cleaning.

A number of apparatuses for and methods of treating food products to reduce the level of pathogens and other contaminants are readily available in the prior art. For instance, U.S. Publication No. 2006/0040029 to Gunnawardena, et al. describes a dry food pasteurization apparatus and method that includes a conveyor which directs the dry food goods through a pasteurization chamber that heater/water supply system that directs hot moist air into the chamber and onto the dry goods so the moist air will condense on the surface of the dry goods so as to produce sufficient heat of condensation to reduce the level of pathogens on the dry goods. U.S. Publication No. 2008/0026123 to Long, et al. describes an apparatus and process for pasteurizing shelled almonds that counter flows the almonds through a saturated steam to elevate the temperature of the exterior surface of the almonds and then counter flows the almonds in dry air prior to discharging the pasteurized almonds. U.S. Publication No. 2009/0311392 to Newman describes a method and apparatus for detoxifying nuts, grains, fruits and vegetables that comprises a combined treatment of water, a heating source and a source of a defined wavelength UV light. The apparatus and system of Newman is configured to be modular for easy, quick and low cost adaptation of the decontamination and/or detoxification of a variety of foodstuffs. U.S. Pat. No. 5,546,849 to Shefet describes a hydrostatic heating apparatus comprising an enclosed chamber having a heated hydrostatic liquid therein through which food products are conveyed by a conveyor that is configured to place the products under hydrostatic pressure in the heating zone.

Despite the availability of the above and other prior art apparatuses, systems and methods of treating food products, what is needed is an improved system for and method of treating food products to reduce the level of pathogens and other contaminants that is able to more efficiently and effectively accomplish the desired treating objectives. Such a system and method should be configured to allow the user thereof to treat a variety of food products to reduce the amount of pathogens and contaminants thereon to an industry acceptable and safe level in a manner that does not damage the food products. The preferred system and method should be adaptable for use in the field for those food products, such as lettuce and cantaloupes, that are primarily handled and packaged in the field and for those food products, such as most nuts and other dry food products, that are processed in a processing facility. Preferably, the new system and method for treating food products should be configured to completely, but cost efficiently, separate the handling of the raw food products from the processed food products so as to avoid contamination of the clean food products. The system and method should be adaptable to a wide variety of different processing arrangements that are utilized to achieve different pathogen treating requirements and other food processing objectives, such as roasting, blanching, brine soaking, seasoning and the like. Preferably, the new system and method will be cost effective to utilize and be adaptable for modular installation to facilitate relatively easy and quick modification of existing facilities.

### SUMMARY OF THE INVENTION

The new system and method of the present invention provides the benefits and solves the problems identified above. That is to say, the present invention discloses a system and method for treating food products that enables the user thereof to efficiently and effectively reduce the level of pathogens and other contaminants thereon. The packaging system and method of the present invention facilitates the handling of raw food products in a manner that allows the user thereof to achieve a variety of desired or required food treatment objectives. The system and method of the present invention is adaptable to treating food products to reduce the level of pathogens and/or other contaminants in the field or in a processing facility. The system and method of treating food products allows the user to effectively and efficiently reduce the level of pathogens to the desired or required level in a manner that does not damage the food products. The new system and method for treating food products of the present invention allows the user to completely and cost efficiently separate the handling of raw food products from the handling of the processed food products to reduce the likelihood of any post-cleaning contamination of the clean food products. The present system and method is easily adaptable to a wide variety of processing arrangements as may be selected by the user to achieve different pathogen treating requirements and other food processing objectives, including but not limited to roasting, blanching, brine soaking, seasoning and the like. The new system and method of the present invention are cost effective to implement and utilize and are readily adaptable to modular installation so as to facilitate relatively easy and quick modification of existing food processing facilities.

In a preferred configuration of the present invention, the system for treating food products to reduce the level of pathogens and other contaminants generally comprises a conveying mechanism having an elongated tube with a conveyor apparatus that is moveably disposed through the interior of the tube, a product compartment that is conveyed by the conveyor apparatus through the tube, a modular treatment unit having a tube section that is connected to the tube so as to receive the conveyor apparatus and the product compartment into an interior area of the tube section, an input mechanism that is associated with the conveying mechanism for placing the food product into the product compartment prior to the product compartment being received into the modular treatment unit, a treating apparatus structured and arranged to discharge treated air to the tube section of the modular treatment unit while the product compartment is in the tube section and a controller that is connected to the conveyor apparatus, the food product placing mechanism and the treating apparatus, with the controller being configured to monitor and/or control these components of the system and, as desired, to control and/or monitor various other components of the system. The modular treatment unit has an input manifold that is attached to or integral with the tube section, a plurality of input perforations disposed in the tube section at the input manifold to place the input manifold in fluid flow communication with the interior area of the tube section, an exhaust manifold that is also attached to or integral with the tube section and a plurality of exhaust perforations disposed in the tube section at the exhaust manifold to place the exhaust manifold in fluid flow communication with the interior area of the tube section. The input manifold is in fluid flow communication with the treating apparatus to receive treated air from the treating apparatus. The input manifold directs the treated air into the product compartment through the input perforations to treat the food product with the treated air when the product compartment that is conveying the food product is positioned in the interior of the tube section. The treated air produces a treated food product. The exhaust perforations are sized and configured to allow exhaust air to flow from the product compartment into the exhaust manifold and, in one configuration, back to the treating apparatus where the exhaust air is treated by the treating apparatus to produce the treated air. In a preferred configuration, the input perforations and the exhaust perforations are respectively positioned so as to define an offset spacing with the input perforations starting before the exhaust perforations and the exhaust perforations ending beyond the end of the input perforations. The offset spacing is selected to seal the treated air in a treating area defined by the product compartment. The treating apparatus comprises a duct that is configured to allow air to pass therethrough, a temperature adjusting mechanism that is configured to heat and/or cool the air in the duct and a fan that is configured to pressurize the air and direct the air to the input manifold. The fan can also be configured to draw in the exhaust air from the exhaust manifold. The treating apparatus can include a pressurized spray nozzle or other apparatus that is configured to spray water or other fluid from a fluid supply into the duct so as to increase the humidity of the treated air. Preferably, the system also includes a by-pass apparatus that is positioned after the second end of the tube section that is structured and arranged to selectively divert treated food product from the conveying mechanism if the controller and/or the user determines that some of the food product was improperly or incompletely treated.

In one embodiment, the method of treating a food product to reduce the level of pathogens and other contamination of the present invention generally comprises the steps of: (a) placing the food product in a product compartment of a conveying mechanism that has an elongated tube and a conveyor apparatus which is moveably disposed through the tube; (b) moving the food product in the product compartment on the conveyor apparatus to a modular treatment unit that has a tube section which is connected to the tube so as to receive the conveyor apparatus and the product compartment into an interior area of the tube section; (c) directing treated air from a treating apparatus to the product compartment that has the food product through a plurality of input perforations which are disposed in the tube section so as to treat the food product with the treated air and produce a treated food product; (d) flowing exhaust air from the product compartment through a plurality of exhaust perforations that are disposed in the tube section, with the respective positions of the input and exhaust perforations defining an offset spacing that is selected so as to seal the treated air in a treating area of the product compartment; and (e) conveying the treated food product to a clean room or other area for further processing and/or packaging of the treated food product. In a preferred configuration, the method further comprises the step of diverting any untreated or improperly treated food product, as may be necessary, before the conveying step in order prevent the untreated or improperly treated food product, which may be contaminated with a pathogen or other contaminate, from being discharged as “good” treated food product. Preferably, the directing step directs the treated air into an input manifold prior to passing through the input perforations and the flowing step flows the exhaust air into an exhaust manifold after flowing through the exhaust perforations, with each of the input and exhaust manifolds being sealably attached to or integral with the tube section of the modular treatment unit.

Accordingly, one of the primary aspects of the present invention is to provide a new system and method for treating food products to reduce the level of pathogens and other contaminants that has the advantages discussed above and which overcomes the various disadvantages and limitations associated with presently available systems and methods for treating food products.

It is also an important aspect of the present invention to provide a new food product treating system and method of use thereof that is adaptable to treating a wide variety of different food products and which can be utilized in the field or in a processing facility to reduce the level of pathogens and/or other contaminants to an acceptable safe level for the consumer of the food products.

It is also an important aspect of the present invention to provide a system and method for treating food products to reduce the level of pathogens and other contaminants that facilitates completely and efficiently treats the food products without damaging the food product.

It is also an important aspect of the present invention to provide a system and method for treating food products that facilitates the user thereof being able to separate the handling and processing of clean food products from the handling and processing of raw food products.

It is also an important aspect of the present invention to provide a system and method for treating food products to reduce the level of pathogens and other contaminants that is relatively easily and cost efficient to adapt to existing apparatuses, systems and methods of treating food products.

It is also an important aspect of the present invention to provide a system and method for treating food products to reduce the level of pathogens and other contaminants that can be configured as a modular arrangement to facilitate modifying the treating system and method to achieve different treating and processing objectives.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a system diagram illustrating the general components of a system for treating food products to reduce pathogens and other contaminants that is configured according to a first embodiment of the present invention;

FIG. 2 is a system diagram illustrating the components of the system of FIG. 1 for use in association with a processing facility having a raw product room and a clean room;

FIG. 3 is a system diagram more specifically illustrating the various components of the system of FIG. 2, with the system shown having two modular treatment units;

FIG. 4 is a system diagram showing of the system for treating food products of FIG. 1 more specifically showing the modular treatment unit having a food product therein and the components of the treating unit;

FIG. 5 is a cross-sectional end view of the modular treatment unit of FIG. 4 taken through lines 5-5 of FIG. 4 shown without the food product in the tube section thereof;

FIG. 6 is a cross-sectional end view of a modular treatment unit configured according to an alternative embodiment of the present invention;

FIG. 7 is a system diagram illustrating the general components of a system for treating food products to reduce pathogens and other contaminants that is configured according to a second embodiment of the present invention;

FIG. 8 is a cross-sectional end view of the modular treatment unit of FIG. 7 taken through lines 8-8 of FIG. 7;

FIG. 9 is a side view of a modular treatment unit configured for use with a preferred configuration of the system of the present invention; and

FIG. 10 is a flow chart summarizing of a method of treating food products to reduce the level of pathogens and other contaminants according to one embodiment of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein set forth certain examples of the system and method of the present invention, food products which can be treated with the system and method and various arrangements of the components utilized for the system and method, those skilled in the art will readily understand that the examples are merely provided for the purpose of explaining the present disclosure and that the present invention is not so limited.

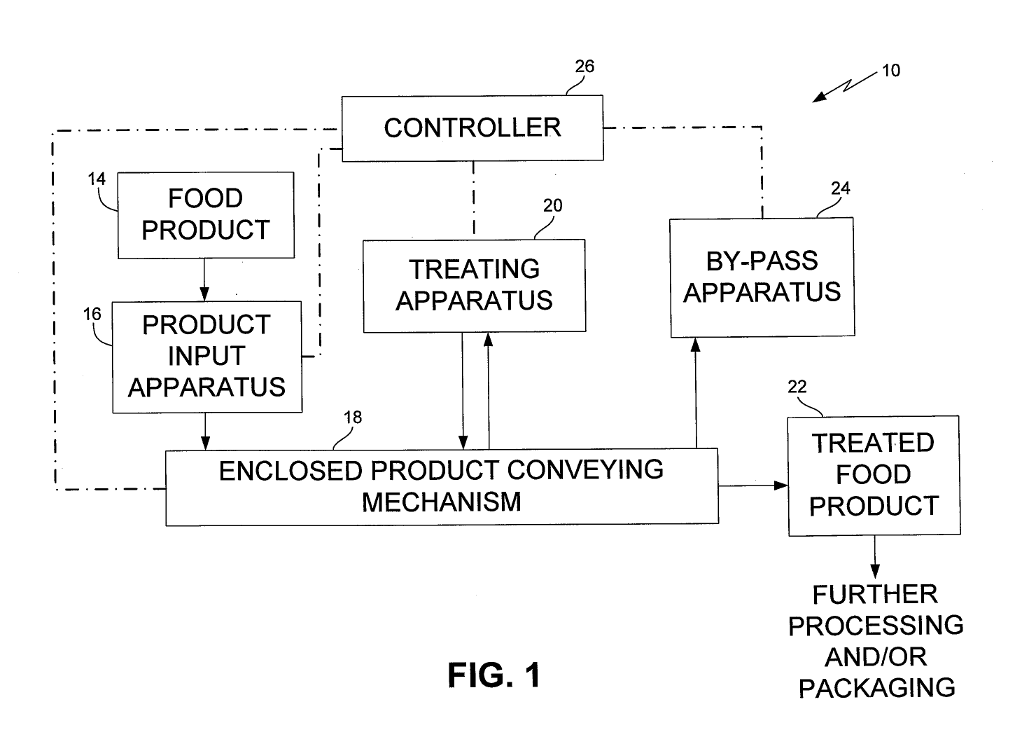

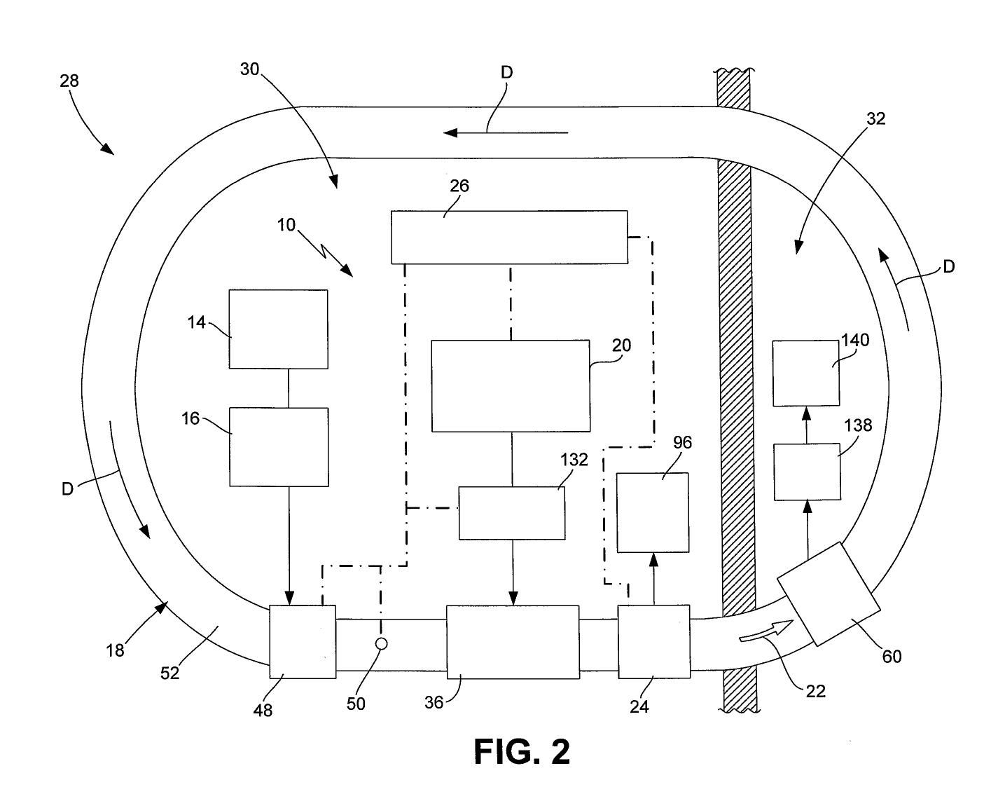

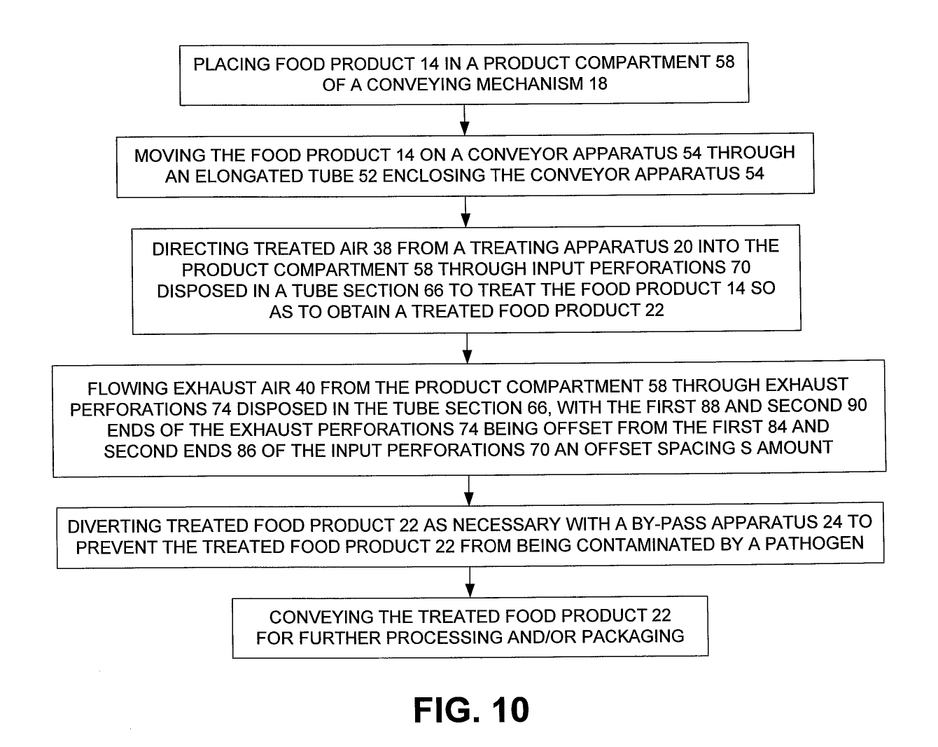

A treating system that is beneficially configured for according to one or more embodiments of the present invention is shown generally as 10 in FIGS. 1-4 and 7. A method that is configured to a preferred embodiment of the present invention is identified as 12 in FIG. 10. As set forth in more detail below and shown in the various figures, the system 10 for treating a food product 14 to reduce the level of pathogens and other contaminants generally comprises a food product input apparatus 16 that directs a selected quantity of food product 14 into an enclosed product conveying mechanism 18 so the food product 14 can be acted upon by a treating apparatus 20 to achieve the desired treating and/or processing objectives. Once treated, the system 10 discharges the food product 14 as treated food product 22 for further processing and/or packaging, as desired by the user of system 10, as described below and shown in FIG. 2. Typically, the system 10 also includes a by-pass apparatus 24 that allows the user to divert any food product 12 that is not fully or properly treated so it will not exit the system 10 as treated food product 22. The system 10 includes a controller 26 configured to control the operation of the product input apparatus 16, conveying mechanism 18, treating apparatus 20 and by-pass apparatus 24, as well as any other components as desired by the user of system 10. The controller 26 has an appropriately configured computer controller mechanism that monitors, analyzes and manipulates the operation of the system 10. Typically, one or more user interface devices, such as keypads, mouse and/or screen, are associated with the controller 26 so the user may input the desired operational parameters and control the on/off operation of system 10 and, as desired, any other functions of system 10. As will be readily appreciated by those skilled in the art, the controller 26 may be hard-wired to one or more of the various components of system 10 and/or controller 26 may be wirelessly connected to one or more components of the system 10. The various operational parameters that may be desired to be monitored, analyzed and controlled by the controller 26 will be readily apparent to persons skilled in the relevant art from the discussion below regarding the operation of system 10.

The embodiment of system 10 shown in FIG. 1 can be utilized with either field treating of food products 14, such as is typical for lettuce, cantaloupes, watermelons and like food products 14 that are harvested and then processed for delivery to the consumer in the field, or food products 14 that are harvested and then delivered to a processing facility for treatment. In either configuration, the treating apparatus 20 used with system 10 and method 12 is selected by the user to accomplish the treating objectives that are desired for food product 14. As will be readily appreciated by persons skilled in the art, the treating apparatus 20 of system 10 and method 12 can be configured to treat for a wide variety of different pathogens, including E. coli, listeria, salmonella and other viruses, bacterium or the like, and a wide variety of other food contaminants which are desired to be removed, or at least substantially removed, from food products 14 to obtain the treated food products 22. For purposes of the present invention, all pathogens and other contaminants which are or can be associated with food products 12 that are or may be desired to be reduced or completely removed, if possible, are hereinafter referred to generally as “pathogens” (including those contaminants that may or may not be human pathogens). The treating apparatus 20 of system 10 may be selected to generally treat the food products 14 so as to reduce and/or remove (i.e., kill) a wide variety of different types of pathogens from food products 14 or it may be selected so as to reduce/remove specific pathogens therefrom. The treating apparatus 20 may be selected to treat the food products 14 in a manner that, in addition or alternatively to treating for pathogens, is desirable for treated product 22 for taste, marketing, storage or other purposes. For instance, food products 14 may be beneficially treated by washing, drying, roasting, blanching, softening, brine soaking, seasoning and the like (hereinafter referred to as “enhancing”). As will be readily appreciated by those skilled in the art, the treating apparatus 20 of system 10 is intended to incorporate all of the pathogen, enhancing and other treating processes which may be utilized with regard to food products 14, which for purposes of the present invention may be any type of food item, including vegetables, fruits, nuts, grains and the like, that is harvested raw and which needs to be treated prior to being made available to the consumer or others (e.g., cereal and candy producers).

The use of system 10 in combination with a processing facility 28 is shown in FIG. 2. The processing facility 28 generally comprises a raw product area 30 that receives and processes the raw food products 14 and a clean room 32 that receives and processes the treated food products 22. As well known in the art, clean room 32 is structured and arranged to prevent any contamination from the raw product area 30, including contamination from the raw food products 14 and the various equipment, machines and the like utilized in the raw product area 30. The typical processing facility 28 is laid out or otherwise configured to specifically prevent raw food products 14 from entering the clean room 32 (when utilized in the prior art) and to prevent people, machines, tools and the like from entering the clean room 32 unless the proper precautions, such as sterilization, coveralls, glasses, hand washing and the like, have taken place to prevent transmission any pathogens to the clean room 32. Typically, the clean room 32 is physically separated from the raw product area 30 by a wall 34 or other barrier that prevents access into clean room 32 except through one of the limited and controlled entrances, such as a door or inlets for the treated product 22. Despite the best efforts, contamination of the clean room 32 is nevertheless possible. As a result, the operator of processing facility 28 will periodically do a thorough cleaning of the clean room 32 to ensure that pathogens are not transmitted to the treated product 22 in the clean room 32. To facilitate the cleanliness of the clean room 32, most of the equipment and machines in the clean room 32 are configured (e.g., made of stainless steel or the like) and/or selected for their ability to reduce the likelihood of pathogen transmission and their ability to be clean (e.g., sterilized). As well known in the art, the process of cleaning the clean room 32 requires the equipment and machines therein to be shut down for the duration of the cleaning process, which may take several days. This often requires the entire processing facility 28 to be shut down, resulting in a loss of production therefrom, which can be quite costly for the owner or operator of the processing facility 28. However, it is generally accepted that the cost of cleaning the clean room 32 and the loss of production from the processing facility 28 is much less expensive than having a contaminated food product being delivered to the consumer.

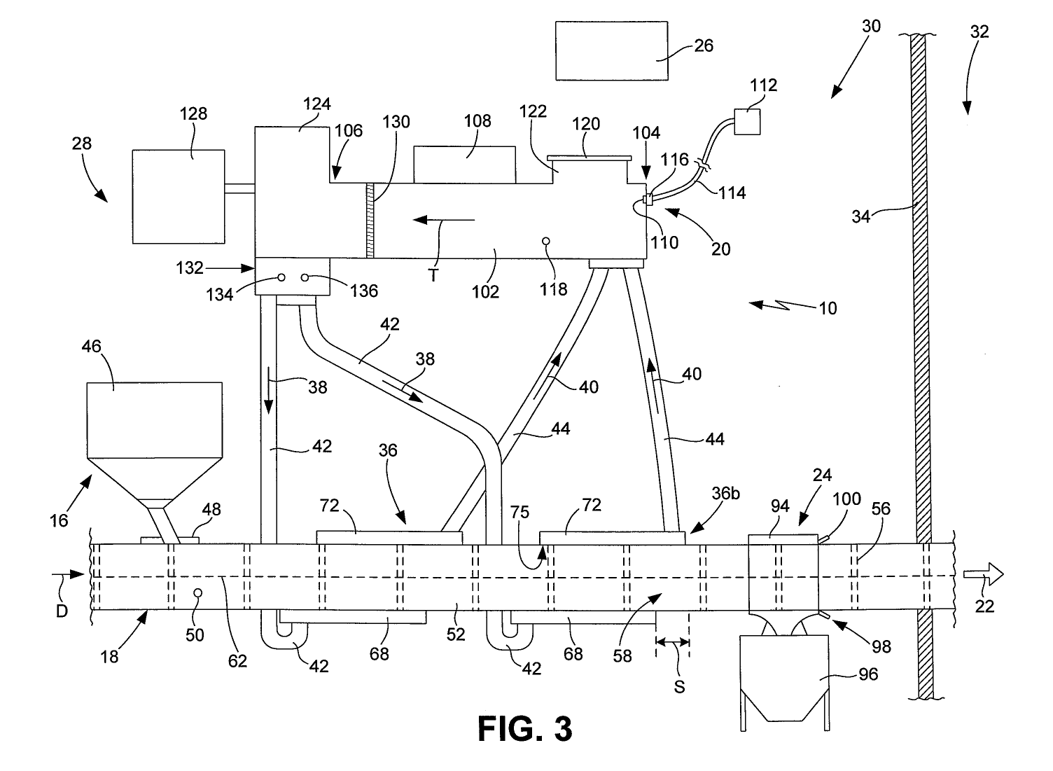

The system 10 and method 12 of the present invention significantly reduces the cost of cleaning, substantially reduces the likelihood of contamination of the clean room 32 and provides significantly improved flexibility with regard to treating the food products 14 (whether for pathogen reducing, product enhancing or etc.). As set forth in more detail below, the preferred embodiment of system 10 comprises one or more modular treatment units 36. As shown in FIG. 3, typically the system 10 will comprises a plurality of modular treatment units 36, such as the first modular treatment unit 36a and second modular treatment unit 36b that are sealably connected to the conveying mechanism 18 to interconnect the conveying mechanism 18 with one or more treating mechanisms 20. As explained in more detail below and best shown in FIG. 3, treated air 38 from the treating mechanism 20 is directed to and into the interior of the modular treatment unit 36 to treat the food product 14 being conveyed by the conveying mechanism 18 and exhaust air 40 flows from the conveying mechanism 18, or the modular treatment unit 36 thereof, to the treating mechanism 20. When one or more modular treatment units 36 are utilized, the treated air 38 flows through an input pipe 42 connecting the treating apparatus 20 and the modular treatment unit 36 to deliver treated air 38 to the food product 14 being conveyed by the conveying mechanism 18. The exhaust air 40 flows through an exhaust pipe 44, which also connects the treating apparatus 20 and the modular treatment unit 36, to flow the exhaust air 40 to the treating apparatus 20. The details regarding the movement of the treated air 38 to and through the conveying mechanism 18, or when utilized the modular treatment unit 36, and the movement of the exhaust air 40 from the conveying mechanism 18 or modular treatment unit 36 to the treating apparatus 20 is set forth below.

The system 10 and method 12 of the present invention comprises a number of components and combinations of components that are structured and arranged to controllably receive raw food product 14 into the enclosed product conveyance mechanism 18, through the product input apparatus 16, and then transport that food product 14 through one or more modular treatment units 36 where the raw food product 14 is treated with the treated air 38 from the treating apparatus 20, via the input pipe 42. Each of the modular treatment units 36 are configured to treat a quantity of the raw food product 14 in a treatment area that is separated from areas having either untreated, partially treated or completely treated (e.g., treated food product 22) food products. Typically, at a minimum, the components and configuration of the treating apparatus 20 will be selected so the treated air 38 that is directed through the raw food products 14 in a particular modular treatment unit 36 will achieve a desired amount of biological reduction in the amount of pathogens which are or may be associated with the food product 14. As will be readily appreciated by persons skilled in the art, the amount of pathogen reduction for a particular modular treatment unit 36 will depend on the type of food product 14 and the configuration and operation of treating apparatus 20. Depending on the variables selected by the user, a single modular treatment unit 36 may be able to provide the entire amount of pathogenic treatment that is necessary to achieve the desired safe treated food product 22 or the pathogenic treatment will have to take place over two or more modular treatment units 36. Specifically, in some configurations of system 10, the user may determine it is more cost efficient and effective to provide the complete pathogenic treatment in one modular treatment unit 36, which may require a more expensive and/or complicated treating apparatus 20, or the user may determine it is more cost efficient and effective to treat the raw food products 14 over multiple modular treatment units 36. In addition, the user may desire to separate the pathogen treating aspects of the system 10 and method 12 from the treatment processes that are utilized to alter or enhance the food product 14 for flavor, texture and etc. For this configuration, the pathogenic treatment of raw food product 14 will occur in a modular treatment unit 36 that is separate from a modular treatment unit 36 which is provided to achieve the desired enhancement of the raw food product 14. For instance, in FIG. 3, the first modular treatment unit 36a can be configured to treat the food product 14 to achieve a desired pathogen reduction level and the second treatment unit 36b can be configured to flavor or otherwise enhance the treated food product 22. Alternatively, both the first 36a and second 36b modular treatment units can be configured to provide pathogenic reduction.

The modular treatment units 36 utilized to treat the raw food product 14 for pathogens are selected, whether singularly or in combination, to achieve a certain amount of pathogen reduction. As will be readily appreciated by those skilled in the art, it is unlikely that all of the pathogens associated with the food product 14 can be killed. As with all treatment processes, the operator of the system 10 must achieve a balance between degradation of the food product 14, which is obviously not desired, and lowering the level of pathogens to an allowed or an acceptable level. While the operator could achieve the complete removal of pathogens if desired, this would generally also result in the complete destruction of the food product 14. As a result, one of the primary objectives of the system 10 and method 12 of the present invention is to assist the operator with reducing the level of pathogens to as low as level as practical without degrading the food product 14. An advantage of the system 10 and method 12 is that food products 14 which could benefit from pasteurization but are not presently pasteurized due to the difficulty in achieving pasteurization without significant degradation of the food product, such as lettuce, tomatoes, grapes and the like, can be beneficially treated by the system 10 and according to the method 12 to substantially reduce pathogen levels without degradation of the food product 14.

The product input apparatus 16 of a typical processing facility 28 comprises a bulk product bin or other product storage unit 46 that receives and stores a quantity of food product 14 that is to be treated using the system 10 and method 12 of the present invention, as shown in FIG. 3. Operatively connected to or otherwise associated with product storage unit 46 is a feeder mechanism 48 that is configured to controllably direct the raw food product 14 into the enclosed product conveying mechanism 18. Preferably, the feeder mechanism 48 is either configured to direct a selected amount of food product 14 into the conveyance mechanism 18 or, likely more practical, the feeder mechanism 48 is configured to measure the amount food product 14 placed into the conveyance mechanism 18. The configuration and operation of such feeder mechanisms 48 are well known in the art. For instance, feeder mechanism 48 may comprise a vibrator apparatus or other input control apparatus that controllably discharges food product 14 into the conveyance mechanism 18 and/or a weigh belt or other product measuring device that measures (e.g., by weight or volume) the amount of food product 14 that was placed into the conveyance mechanism 18 by the feeder mechanism 48. As will be readily appreciated by those skilled in the art, it is likely to be important to the pathogen or other treatment of the food product 14 to know how much food product 14 is being treated in the modular treatment unit 36. In a preferred embodiment, the system 10 also includes a temperature probe 50, shown in FIG. 3, that is positioned to monitor the temperature inside the enclosed product conveyance mechanism 18 prior to the food product 14 entering the first modular treatment unit 36. The information pertaining to the quantity of food produce 14 being treated and the temperature inside the conveyance mechanism 18 prior to the first modular treatment unit 36 are monitored by the controller 26 and utilized thereby to adjust, as necessary, the operational parameters of treating apparatus 20. If desired, the controller 26 may also be utilized to control the amount of food product 14 entering the conveyance mechanism 18, the temperature inside the conveyance mechanism 18 prior to one or more of the modular treatment unit(s) 36 and/or any other parameters that may be useful for achieving the desired treated food product 22.

As stated above, the enclosed product conveying mechanism 18 is structured and arranged to convey the raw food product 14 through the modular treatment unit(s) 36 where the food product 14 is treated by the treated air 38 from the treating apparatus 20 to achieve the desired treated food product 22. As will be readily appreciated by those skilled in the art, the conveyance mechanism 18 is completely sealed from the input of the raw food product 14 at the feeder mechanism 48 until the treated food product 22 is discharged therefrom in the clean room 32 for further processing and/or packaging therein. The input of the treated air 38 and the discharge of the exhaust air 40 are controlled to maintain the sealed nature of the enclosed product conveyance mechanism 18. As a result, the system 10 of the present invention provides a self-cleaning product conveyance mechanism 18, which will substantially reduce the amount of down time that is necessary to clean the processing facility 28 in order to maintain the level of cleanliness that is needed to prevent problematic pathogen contamination of the treated food product 22.

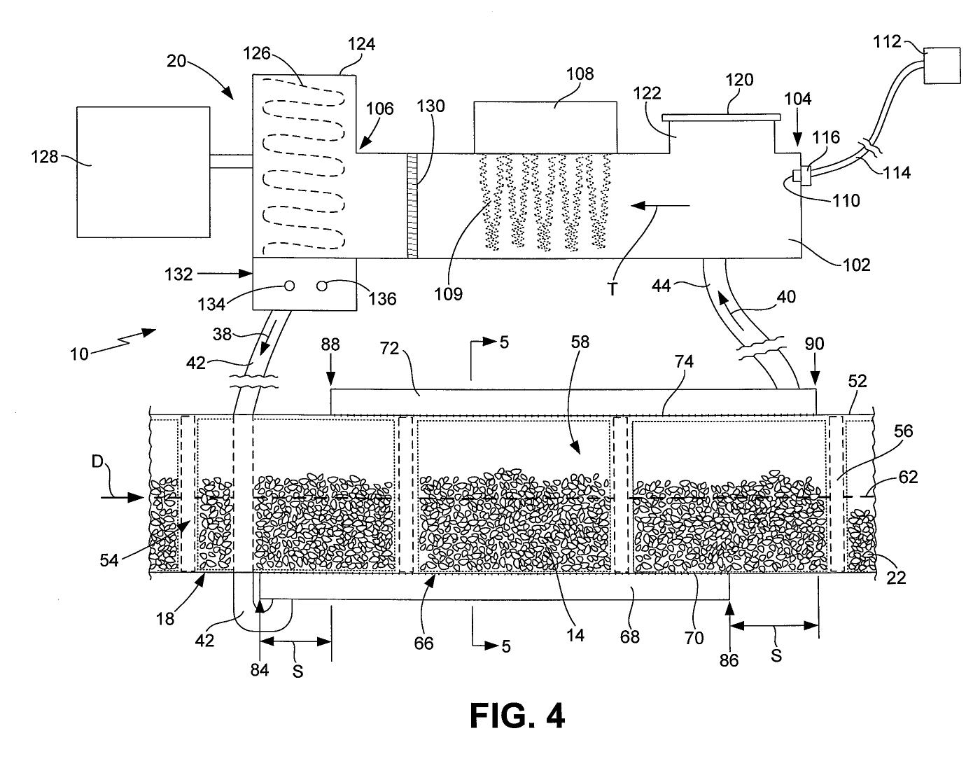

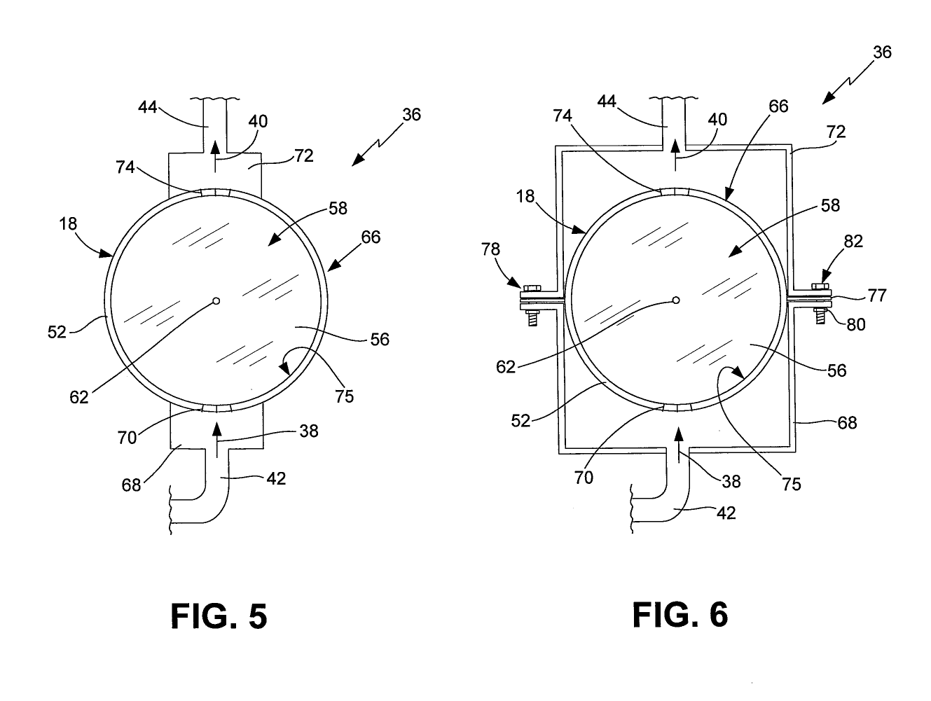

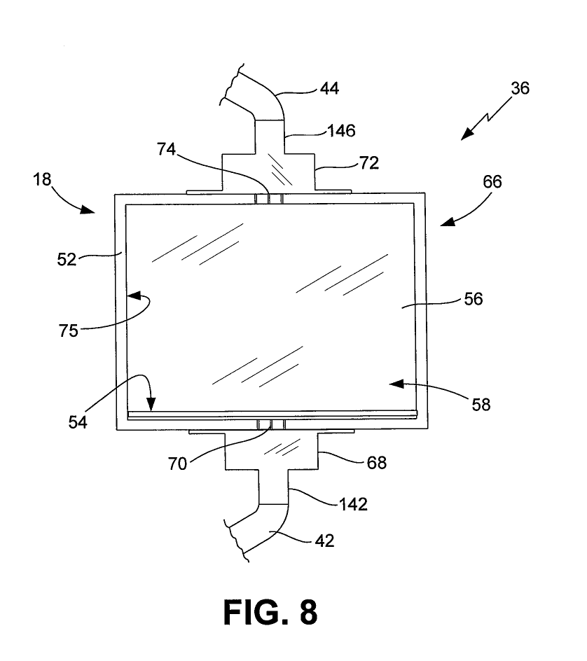

The conveyance mechanism 18 of the present invention comprises an elongated tube 52 that encloses a conveyor apparatus 54 which is configured to move food product 14 from the product input apparatus 16 through the modular treatment unit(s) 36 to obtain the treated food product 22 and move the treated food product 22 into the clean room 32 where the treated food product 22 is discharged from the sealed tube 52 for further processing and/or packaging. The sealed tube 52 may have a round cross-section, as shown in FIG. 5, a square cross-section as shown in FIG. 8, or a rectangular, octagon or a variety of other cross-sectional shapes. As described in more detail below and best shown in FIGS. 3 and 4, the conveyor apparatus 54 has a plurality of dividers 56 that are configured such that a pair of adjacent, spaced apart dividers 56 define a plurality of separate product compartments 58, as best shown in FIGS. 3 and 4. Each of the product compartments 58 define a relatively small, discrete treating area where the food product 14 can be more thoroughly and completely treated by the treated air 38 from the treating apparatus 20. Each product compartment 58 in the tube 52 of the enclosed product conveying mechanism 18 is separate from its adjacent product compartment 58 to provide a non-contiguous arrangement of treating areas. Initially, the food product 14 is directed into one of the product compartments 58 by the feeder mechanism 48 at product input apparatus 16. The food product 14 is moved through the modular treatment unit(s) 36, where food product 14 is treated with treated air 38 in the same product compartment 58 in which it was placed by feeder mechanism 48. The treated food product 22 is then conveyed in the same product compartment 58, which was also cleaned by treating apparatus 20, to the clean room 32 where the treated food product 22 is discharged by a treated product discharge apparatus 60, shown in FIG. 2, for further processing and/or packaging.

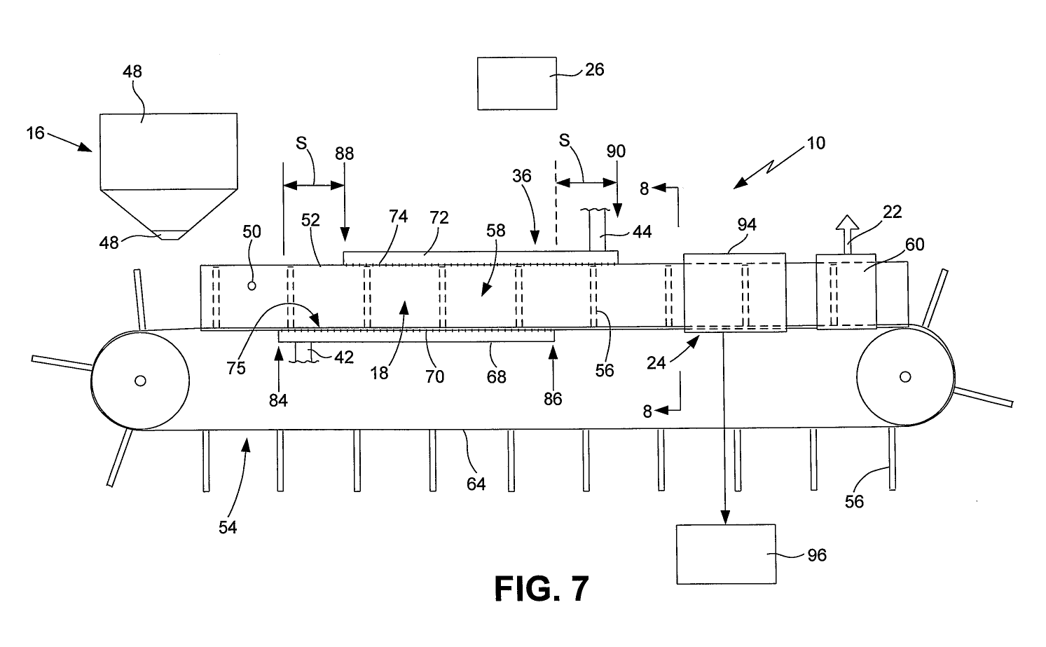

As will be readily appreciated by those skilled in the art, a variety of different conveyor apparatuses 54 can be utilized with the conveying mechanism 18 of the present invention. In the embodiment shown in FIGS. 3 through 6, the conveyor apparatus 54 is of the drag chain conveyor type having a chain, cable, bar or like elongated member 62 interconnecting each pair of dividers 56, which are commonly referred to as pucks, so the dividers 56 and product compartments 58 defined thereby will be moved along inside the tube 52 in the desired direction of travel, shown as D, to convey the raw food product 14 through the modular treatment unit(s) 36 and move the treated product 22 to the clean room 32. In the embodiment of FIGS. 3 through 6, the dividers 56 are circular shaped to match the round cross-section of the tube 52. Product compartments 58 are defined by the inner surface of the sidewall(s) of tube 52 and the space between a pair of adjacent dividers 56. In the embodiment of FIGS. 7 and 8, which is explained in more detail below, the conveyor apparatus 54 comprises a flat belt 64 having a plurality of dividers 56, which may be drag flats or the like, attached thereto in spaced apart relation to each other to define the product compartments 58 between the flat belt 64 and the inner surfaces of the top and sidewalls of tube 52 and the space between a pair of adjacent drag flats 56. The flat belt 64 can be perforated to allow treated air 38 to flow into the food product 14 or, preferably, the flat belt 64 can be made from a stainless steel mesh or mesh-like material that allows the treated air 38 to flow through product compartment 58. In either embodiment, the dividers 56 are sized and configured to sealably engage the inner surface of the sidewalls of the tube 52 so as to provide a sealed product compartment 58 between each adjacent pair of dividers 56. In this manner, the raw food product 14 in a particular product compartment 58 will be completely separated from the treated food product 22 in the area of the modular treatment units 36.

As best shown in FIGS. 4 through 9, each modular treatment unit 36 comprises a tube section 66, an input manifold 68, a series of input perforations 70 in the tube section 66 in the area of input manifold 68, an exhaust manifold 72, and a series of exhaust perforations 74 in tube section 66 in the area of exhaust manifold 72. The tube section 66 has an inner surface 75 that defines the interior 76 of the tube section 66, as best shown in FIGS. 5-6 and 8-9, through which the conveyor apparatus 54 is received, as best shown in FIGS. 4 and 7. The product compartments 58 in the tube section 66 is defined by the inner surfaces 75 and dividers 56. In the embodiment where the tube section 66 is integral with the tube 52 (i.e., non-replaceable modular treatment unit 36), the inner surface 75 is contiguous with the inner surface of the tube 52, as shown with regard to the embodiment of FIG. 3.

As best shown in FIGS. 5, 6 and 8, the input pipe 42 is connected to the input manifold 68 so the treated air 38 will flow into the input manifold 68 and the exhaust pipe 44 is connected to the exhaust manifold 72 so exhaust air 40 will flow from the exhaust manifold 72 to the exhaust pipe 44. As will be readily appreciated by those skilled in the art, treated air 38 from the treating apparatus 20 will flow from the input pipe 42, into the input manifold 68, through the input perforations 70 and into the product compartment 58 so as to pass over the food product 14 therein and to treat the food product 14 as desired by the user (e.g., so as to reduce pathogens thereon, enhance the food product 14 or etc.). After the treated air 38 passes over and treats the food product 14, exhaust air 40 will pass through the exhaust perforations 74, into the exhaust manifold 72 and into the exhaust pipe 44, where it will be directed back to the treating apparatus 20 to define a closed-loop system 10. Each of the input manifold 68 and the exhaust manifold 72 are sealably attached to or made integral with the tube section 66 so as to prevent loss of treated air 38 from the input manifold 68 and loss of exhaust air 40 from the exhaust manifold 72. Likewise, tube section 66 is cooperatively configured with the tube 52 so the tube section 66 is sealably connected to the tube 52 to form a continuous sealed tube 52 (including tube section 66 therein). A variety of tube connecting mechanisms can be utilized with the system 10, the configuration and use thereof being known to those skilled in the art, to connect tube section 66 to tube 52. In an alternative embodiment, tube section 66 is an integral part of the tube 52. However, as will be readily appreciated by persons skilled in the art, use of a separate tube section 66 provides independent modular treatment units 36 that can be selectively added to or removed from the tube 52 to allow the user to quickly, easily and for relatively low cost modify the treatment which is provided by the system 10 and method 12 of the present invention.

As stated above, the input manifold 68 and the exhaust manifold 72 can be integral with or attached to the tube section 66 to define an individual modular treatment unit 36. In the embodiment shown in FIG. 5, the input 68 and exhaust 72 manifolds are shown as being integral with or fixedly attached, such as by welding or the like, to the tube section 66. In the embodiment of FIG. 6, the input 68 and exhaust 72 manifolds are removably attached to the tube section 66 so they may be removed for cleaning or, as may be necessary, replacement. In this embodiment, an outwardly extending member 77 is fixedly attached to or integral with the tube section 66 so as to extend outwardly from the outer wall of tube section 66. Each of the input 68 and exhaust 72 manifolds are shaped, such as the L-shape shown in FIG. 6, so as to be placed in abutting engagement with the outwardly extending member 77. A connecting mechanism 78, such as the nut 80 and bolt 82 combination shown in FIGS. 5 and 6, is utilized to clamp a portion of the manifolds 68/72 to the outwardly extending member 77, typically with a sealing member therebetween. In this manner, the input 68 and exhaust 72 manifolds will be sealably but removably attached to the tube section 66. As such, treated air 38 will be forced to flow from the input manifold 68 through the input perforations 70 into the product compartment 58 and exhaust air 40 will be forced to flow into the exhaust pipe 44 from the exhaust manifold 72 after being received therein from the product compartment 58, after flowing over the food product 14, through the exhaust perforations 74.

As best shown in FIGS. 3, 4, 7 and 9, the relative positions of the input perforations 70 and the exhaust perforations 74 (as represented by the ends of the input manifold 68 and the exhaust manifold 72, respectively) are offset from each other, as shown by the offset spacing “S” in these figures. As illustrated in these figures, the upstream and downstream ends of the input perforations 70 are positioned further upstream than the respective upstream and downstream ends of the exhaust perforations 74, with the terms “upstream” and “downstream” being relative to the direction of travel “D” provided by the conveyor apparatus 54 of conveying mechanism 18. More specifically, input perforations 70 have a first or upstream end 84 and a second or downstream end 86 and the exhaust perforations 74 have a respectively positioned first or upstream end 88 and a second or downstream end 90. The two sets of perforations 70/74 are structured and arranged on tube section 66 such that the first end 84 of the input perforations 70 is further upstream (relative to the direction of travel D) than the first end 88 of the exhaust perforations 74 and the second end 90 of the exhaust perforations 74 is further downstream (also relative to the direction of travel D) than the second end 86 of the input perforations 70. The input perforations 70 in the tube section 66 are disposed between the respectively configured first and second ends of the input manifold 68 and the exhaust perforations 74 are disposed between the respectively configured first and second ends of exhaust manifold 72, as shown in FIGS. 4, 7 and 9. Although both sets of perforations 70/74 are shown substantially extending between the ends of their respective manifolds 68/72, those skilled in the art will appreciate that the perforations 70/74 may or may not extend from end to end of the respective manifolds 68/72 and that there may be a gap between the ends of the perforations 70/74 and the respective ends of the manifolds 68/72.

The offset spacing S between the first end 84 of the input perforations 70 and the first end 88 of the exhaust perforations 74 and between the second end 86 of the input perforations 70 and the second end 90 of the exhaust perforations 74, which offset spacing S may be of different lengths, are important for quality control relative to system 10 and method 12 of the present invention. As will be apparent to those skilled in the art, the use of offset spacing S will effectively seal the treating area(s) 92, which are the product compartments 58 that are positioned in the tube section 66 and which are receiving the treated air 38 over the food products 14, so as to prevent any air other than the treated air 38, including air inside the raw product room 30, from getting into the treating area(s) 92 either upstream or downstream of the treating area(s) 92. As set forth below, the treated air 38 is pressurized by one or more components of treating apparatus 20, which is sufficient to keep unwanted air from the raw product room 30 from entering into the treating area(s) 92. In the preferred embodiment, one or more of the components of the treating apparatus 20, such as a fan or the like, is configured to draw in or suction the exhaust air 40 from the exhaust manifold 72 through the exhaust pipe 44. If the system 10 is so configured, the offset spacing S will effectively seal the downstream end of the treating area(s) 92 due to the suctioning of the exhaust air 40 therefrom.

As set forth above, in a preferred embodiment the system 10 of the present invention also comprises a by-pass apparatus 24 that is constructed and arranged to divert any food product 14 that was not properly or completely treated by the treating apparatus 20 during the passage of the food product 14 through the modular treatment unit(s) 36. The typical by-pass apparatus 24 will comprise a diverting mechanism 94 that is configured to divert the untreated or improperly treated food product 14 away from passage into the clean room 32, usually to a diverter bin 96 in fluid flow communication or otherwise associated with diverting mechanism 94, as shown in FIGS. 2, 3 and 7. As best shown in FIG. 2, the diverting mechanism 94 is operatively connected to the controller 26, whether by wire or wirelessly, so controller 26 can either automatically operate the diverting mechanism 94 if the controller 26 detects a problem, usually by way of one or more probes, sensors or other devices which may indicate a treatment failure, or allow the operator to manually engage the diverting mechanism 94 to divert a quantity of food product 14 into the diverter bin 96. Because the need to operate diverting mechanism 94 and divert food product 14 is only operated if the food products 14 in one or more of the product compartments 58 where not properly treated by the treated air 38 from the treating apparatus 20, it is also necessary to provide a cleaning system 98 that automatically cleans the subject portion of the conveying mechanism 18 when the diverting mechanism 94 is operated (whether manually or automatically). As shown in FIG. 3, the cleaning system 98 will be positioned downstream of the diverting mechanism 94 and be configured to clean the entire surface area of the subject product compartments 58 (but only those compartments 58). In the embodiment of FIG. 3, the cleaning mechanism 98 comprises one or more spray nozzles 100, with two shown, that are structured and arranged to direct a cleaning solution, which may contain alcohol and/or other decontaminating solutions, onto the surfaces of the product compartment(s) 58 which previously contained the food product 14 that was diverted to the diverter bin 96 by diverting mechanism 94. Use of the diverting mechanism 94 and the cleaning mechanism 98 ensures that the product compartments 58 that enter into the clean room 32 are clean so as to prevent any pathogens from entering the clean room 32 and contaminating the treated food products 22. In addition, utilization of cleaning mechanism 98 ensures the self-cleaning nature of the system 10 of the present invention. As will be readily appreciated by those skilled in the art, a variety of different devices and solutions can be utilized with cleaning mechanism 98.

As set forth above, the treating apparatus 20 provides the treated air 38 that is utilized to treat the food product 14 in a manner which achieves the desired pathogen reduction and/or enhancement objectives of the system 10 and method 12 of the present invention. Because the objectives may be somewhat varied, the components that make up the treating apparatus 20 are somewhat variable. For instance, in certain circumstances and for certain food products 14 it may only be necessary to direct heated air, as the treated air 38, to the food products 14 to accomplish the desired or required pathogen reduction. In other circumstances, the operator may want to control the humidity of treated air 38 to better achieve the desired treatment objectives. In addition, it may be desirable to pre-treat the food products 14, such as by just directing hot treated air 38 to the food products 14, prior to treating for pathogens or enhancing the food product 14 to better achieve the desired treating objectives. Some food products 14 may need to be cooled by the treating apparatus 20 prior to entering the clean room 32. As set forth in more detail below, a major benefit of system 10 of the present invention is the amount of flexibility which can be achieved utilizing one or more modular treatment units 36 that are connected, via pipes 42/44, to one or more treating apparatuses 20 that are each configured to provide a certain type of treatment to achieve the desired treated food product 22.

A typical treating apparatus 20 will comprise a linearly disposed treating duct 102 having a first or upstream end 104 and a second or downstream end 106, with the terms “upstream” and “downstream” being in reference to the treating flow direction of travel, shown as “T” in FIGS. 3 and 4. To change the temperature of the air flowing through the treating duct 102, treating apparatus 20 will also comprise one or more duct temperature adjusting mechanisms 108 in fluid flow communication with the air flowing through treating duct 102 so as to direct heat or cold, representatively shown as 109 in FIG. 4, into the interior of treating duct 102 to change the temperature of the air flowing therethrough in a desired direction, meaning warmer or cooler, and in the desired amount so the treated air 38 will be at or near the desired temperature when it leaves treating apparatus 20. In one embodiment, the temperature adjusting mechanism 108 is a gas or electrically powered duct heater that heats the air flowing through the treating duct 102, in the treating flow direction T, to produce hot treated air 38, which is then blown across food products 14 in the treating area 92 of modular treatment unit 36. In another embodiment, the temperature adjusting mechanism 108 is a duct chiller that cools the air flowing through the treating duct 102, in the treating flow direction T, to produce cool or cold treated air 38, which is then blown across food product 14 in the treating area 92 of modular treatment unit 36. In yet another embodiment, the temperature adjusting mechanism 108 comprises both a duct heater and a chiller. As stated above, in some embodiments, a first modular treatment unit, such as unit 36a, will receive hot treated air 38 to reduce the level of pathogens and then a second modular unit, such as unit 36b, will receive chilled treated air 38 to cool the treated food product 14 prior to entering the clean room 32 and being discharged from the conveying mechanism 18 by treated product discharge apparatus 60 for further processing and/or packaging in the clean room 32. As will be readily appreciated by those skilled in the art, the temperature of the treated air 38 which is needed to reduce pathogens on a food product 14, without degrading food product 14, is at least somewhat dependent on the food product 14. The need to cool the food product 14 prior to further processing and/or packaging is also very dependent on the food product 14 and/or the desired treated food product 22.

The typical treating apparatus 20 will also include a pressurized sprayer, shown as 110 in FIGS. 3 and 4, that is structured and arranged to inject water or another liquid into the treating duct 102 so as to modify the dew point of the treated air 38. In the embodiment shown in these figures, the pressurized sprayer 110 is hydraulically connected to a supply of liquid 112, via a suitably configured hose or other fluid line 114, and a water pump 116 to controllably spray the pressurized liquid into the treating duct 102 in order to achieve a desired moisture content for treated air 38, as may be needed or desired to treat the food products 14. The pressurized sprayer 110 will be operatively connected to the controller 26 so the controller 26 can monitor and control the injection of fluid, such as water, into the interior of the treating duct 102 to affect the moisture of the treated air 38 in the desired manner. A pressure probe 118 may be utilized with and operatively connected to the treating duct 102 to monitor the pressure inside treating duct 102. The pressure probe 118 will also be connected to the controller 26 so the pressure inside the treating duct 102 can be monitored and controlled. In a preferred embodiment, treating duct 102 will have a removably attached lid 120 at a cleanout entrance 122 into treating duct 102 so the interior of the treating duct 102 may be cleaned out, as may be desired or necessary.

As shown in FIGS. 3 and 4, treating apparatus 20 will also include a fan 124 at or near the second end 106 of the treating duct 102 that is configured to draw air into the heating duct 102 and discharge it, after it is heated, cooled, dew point adjusted or otherwise treated, as treated air 38 into the input pipes 42 connected to the modular treatment unit(s) 36. Typically, fan 124 will include fan blades 126 and will be powered by a fan motor 128. Preferably, fan motor 128 is operatively connected to the controller 26 so the controller 26 may automatically control the speed of the fan motor 128, and therefore the fan blades 126, and/or the user may manually control the speed of fan 124. In a preferred embodiment, the fan 124 is configured to draw in the exhaust air 40 into the treating duct 102 from the exhaust manifold 72 through the exhaust pipe 44 and then recondition that air for discharge as treated air 38. The preferred embodiment of the treating apparatus 20 also includes a perforated screen 130 that is positioned at or near the second end 106 of the treating duct 102 that is structured and arranged to spread the air flow, shown in direction T, out as it enters the fan 124 to make the airflow more uniform.

The preferred configuration of treating apparatus 20 also includes an air flow measurement apparatus 132 comprising one or more measurement devices to measure the various qualities of the treated air 38 as it is discharged from the treating apparatus 20 toward the modular treatment unit(s) 36. In one embodiment, the air flow measurement apparatus 132 includes a temperature and pressure measurement probe 134 to measure the temperature and pressure of the treated air 38 as it flows out of the treating apparatus 20 and a dew point monitor 136 that measures the relative humidity (dew point) of the treated air 38. The air flow measurement apparatus 132, including the temperature/pressure probe 134 and dew point monitor 136, are operatively connected to the controller 126 so the various qualities of the treated air 38 can be monitored and adjusted, whether automatically by controller 26 or manually by the operator. Other probes and other monitors associated with the treating apparatus 20 can monitor and/or measure the quantity of any chemicals or other materials being utilized to kill pathogens and/or the quantity of any seasonings, spices or other enhancement materials being applied to food product 14 to produce treated food product 22.

Once the food products 14 are treated by the treating apparatus(es) 20, the conveyor apparatus 54 of the conveying mechanism 18 moves the treated food product 22 to the clean room 32 where the treated food product 22 is discharged from the tube 52 by the treated product discharge apparatus 60 for further processing and/or packaging. For instance, a typical clean room 32 will have a sorting apparatus 138 allowing for final sorting, typically by hand, of the treated food product 22 for quality control purposes (e.g., size, visual appearance or etc.). Once sorted, the remaining treated food product 22 is conveyed to a packaging apparatus 140 for placing into packages for delivery to the consumer and/or other purchasers of treated food product 22. As well known in the art, the surfaces of the sorting apparatus 138, packaging apparatus 140 and any other machines or equipment which come into contact with the treated food product 22 are typically made out of food grade stainless steel or the like to allow the user to easily, quickly and effectively sterilize the surfaces and to reduce the likelihood of any cross-contamination.

As stated above, the components of the treating apparatus 20 of the system 10 of the present invention are selected to treat the raw food product 14 as desired by the user. Typically, the primary objective of the treating apparatus 20 is to reduce the level of pathogens to an acceptable level without causing any unacceptable degradation or undesired modification of the food product 14. For many food products 14, the pathogens can be reduced to the desired level just by applying heated, dew point controlled air to the food products 14. The system 10 of the present invention facilitates applying climate controlled, pressurized air to a relatively small treating area 92, which is defined by the product compartments 58 of conveying mechanism 18. As stated above, pressurized air from the treating apparatus 20 and the use of offset spacing S for the input perforations 70 and exhaust perforations 74 prevents air from the raw product room 30 (or outside air if system 10 is utilized in the field) from entering into the product treating area 92. If desired, sterilization chemicals can be added to the air or water as it moves through the treating apparatus 20 to achieve higher levels of pathogen reduction. Likewise, treating apparatus 20 can be configured to apply flavoring, seasoning or other enhancements to the food product 14 to obtain the desired treated food product 22.

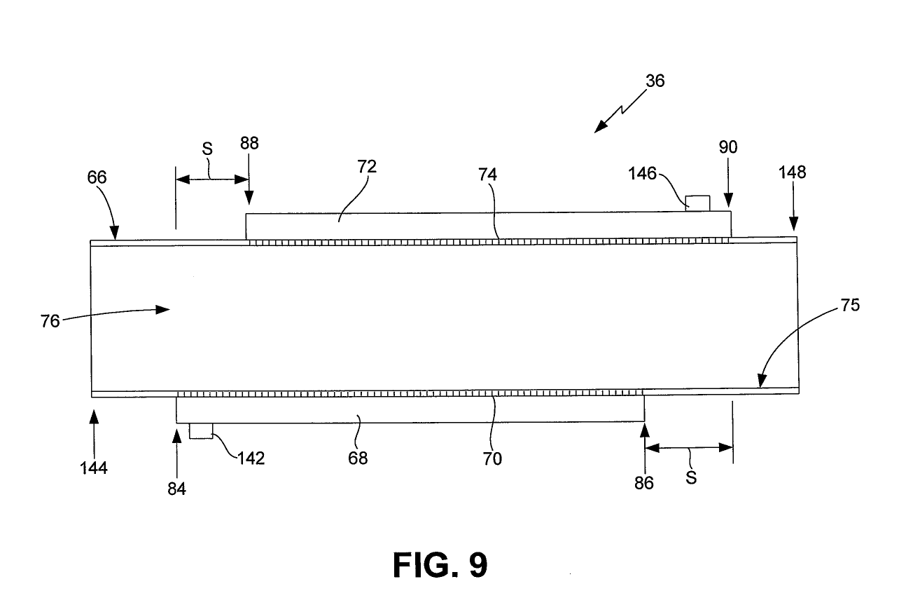

One of the primary advantages of the system 10 of the present invention is the use of one or more modular treatment unit(s) 36 in conjunction with one or more treating apparatus(es) 20. As will be readily appreciated by those skilled in the art, a series of modular treatment units 36 can be connected together and joined to tube 52 and connected to a treating apparatus 20 or a variety of treating apparatuses 20 to provide a wide range of different treating arrangements. As such, the modular treatment units 36 will allow the user to customize the treating process to achieve specific results with regard to the treated food product 22 and/or to address specific concerns (e.g. potential contamination issues) with regard to raw food product 14. As shown in FIGS. 8 and 9, in one embodiment of system 10 the modular treatment unit 36 comprises a tube section 66 with the input perforations 70 and exhaust perforations 74 having the desired offset spacing S, input manifold 68 having an input pipe connection 142 toward the upstream or first end 144 of tube section 66 that is sized and configured for connecting the input pipe 42 thereto and exhaust manifold 72 having an exhaust pipe connection 146 toward the downstream or second end 148 of tube section 66 that is sized and configured for connecting the exhaust pipe 44 thereto. As such, to modify an existing processing facility to use modular treatment unit 36, the ends 144/148 of the tube section 66 are sealably connected to the tube 52 with the conveyor apparatus 54 passing through the interior 76 of the tube section 66 and the pipes 42/44 are connected to their respective connection junctions 142/146. If a new or additional treating process is added to the existing treating process, the pipes 42/44 are connected to the new/additional treating apparatus 20. Once installed, the conveyor apparatus 54 will convey the food product 14 to be treated, in the product compartments 58, through the interior 76 of the modular treatment unit 36 so the treated air 38 from the treating apparatus 20 will be directed into the relatively small treating areas 92 for efficient and effective treating of the food product 14. After the treated air 38 treats the food product 14, the resulting exhaust air 20 will be directed away from the modular treatment unit 36 through exhaust pipe 44.

As stated above, the modular treatment unit 36 can be utilized with a variety of different treating apparatuses 20 to accomplish a wide range of treating objectives. For instance, one or more modular treatment units 36 can be utilized with a treating apparatus 20 that is configured to pre-treat the food product 14 by directing heated air, without any moisture added, as the treated air 38 to the food product 14 in the modular treatment unit 36. One or more modular treatment units 36 can be utilized with a treating apparatus 20 that is configured to kill pathogens through pasteurization of the food product 14 by directing heated, moisturized (dew point controlled) air as treated air 38 to the food product 14 in the modular treatment unit 36. One or more modular treatment units 36 can be utilized as a roaster to roast food product 14 in the modular treatment unit 36. As will be readily appreciated by those skilled in the art, the same treating apparatus 20 can be utilized to accomplish the above pre-treating, pasteurizing and roasting objectives described above by merely controlling the temperature of the air and whether or not any moisture is added to the air. If desired, one or more additional treating apparatuses 20 and/or modular treatment units 36 can be added to direct cool or cold air onto the treated food product 22 to bring the temperature of the treated food product 22 down to near an ambient temperature so it can be further processed and/or packaged. To accomplish the cooling of the food product 22, the modular treatment unit(s) 36 will be connected to a chiller or like cooling apparatus, as the temperature adjusting mechanism 108. Typically, the modular treatment unit(s) 36 utilized for cooling the food product 22 will be positioned after the by-pass apparatus 20 so only “good” treated food product 22 is chilled. Any diverted food product 22 will either be re-worked through the system 10 or rejected.

As will be apparent to those skilled in the art, the use of the modular treatment units 36 in system 10 provides significant advantages over the prior art systems. The smaller sized treating area 92 allows more efficient and effective killing of pathogens due to the greater control which can be applied to that small treating area 92. The arrangement of system 10 is more flexible and requires less floor space than existing treating systems. Unlike prior art treating systems, the system 10 of the present invention is self-cleaning and, as such, is much less expensive to operate and requires significantly less downtime when any cleaning is required. In addition, the use of the modular treatment units 36 for system 10 requires less capital investment than comparable treating systems, particularly with regard to modifying the facility 28 to achieve different treating objectives as each of the modular treatment units 36 are the same, just connected to a treating apparatus 20 so as to accomplish different treating objectives or connected to different treating apparatuses 20 that are selected to accomplish the different objectives. For instance, the same modular treatment unit 36 can be utilized for pre-treating, pathogen reduction, drying, roasting, cooling, plasterizing, blanching, sanitizing, brine soaking, washing or seasoning, as well as other food treating objectives. The modular treatment unit 36 can also be utilized in food treating processes that require or benefit from the food product 14 being moved through a vat or other container having a liquid which is used to rinse, wash, chemically clean, soften, moisturize, brine soak or season the food product 14. Likewise, the modular treatment unit 36 can be utilized with a spray mechanism that sprays the desired liquid onto the food product 14. In either embodiment, the tube section 66 of the modular treatment unit 36 can be provided with one or more drain holes at or near the downstream or second end 148 that allows the liquid to drain away from the food product 14.

As stated above, the system 10 utilizes a controller 26 to monitor and control various aspects of system 10. For instance, the controller 26 can control the rate at which the raw food product 14 is added by feeder mechanism 48, monitor the amount of food product 14 in the product storage unit 46 and adjust the speed of the conveyor apparatus 54. Using a weight or volume measuring device and/or a temperature probe 50, the controller 26 can monitor the food product 14 as it enters the modular treatment unit 36, where the food product 14 will be treated, so that one or more components of treating apparatus 20 can be adjusted as necessary or desired in light of the measured weight, volume and/or temperature. The controller 26 can monitor, as desired, other features of raw food product 14 as it enters the modular treatment unit 36. The controller 26 can also connect, via wired or wirelessly, to probes and other monitoring devices in or on the modular treatment unit 36 or devices that are associated with exhaust manifold 72 or exhaust pipe 42. As stated above, the controller 26 also connects to the treating apparatus 20 to monitor pressure, temperature, dew point, flow rates, fan speeds and other features associated with the treating apparatus 20 and to adjust, as necessary, the operation of one or more of the components of the treating apparatus 20 to accomplish the desired treating objectives, including heating, pasteurizing, roasting, enhancing, cooling and the like. The controller 26 also connects to the diverting mechanism 94 of the by-pass apparatus 24 to divert any treated food products 22 that were not properly or completely treated in the modular treatment unit(s) 36. As previously stated, the controller 26 can be configured to automatically adjust the parameters of system 10 or to allow the user to control one or more of these parameters as may be desired or needed.

As illustrated in FIGS. 2 through 4, the system 10 of the present invention can be utilized in a processing facility 28 to process raw food product 14 into the desired treated food product 22. As may also be readily appreciated by those skilled in the art, the system 10 can also be adapted for use in a field or other outdoor location to field-process the raw food product 14 into treated food product 22. The availability of system 10 will be particularly beneficial for crops such as lettuce, cantaloupes, watermelons and like food products 14 which are generally processed in the field for direct delivery to the consumer and others. As known to those in the food industry, a number of field-processed food products 14 have had pathogen-related health problems that have resulted in many people becoming sick and some people dying. The use of system 10, including the modular treatment unit 36 aspect thereof, will allow field-processed food products 14 to be treated to reduce the level of pathogens and, therefore, reduce the incidences of food-related health problems. As with the use of system 10 in a processing facility 28, the use of the system 10 in the field to reduce pathogens is accomplished without degradation of the treated food product 22.

An embodiment of the system 10 which is particularly suited for use in the field to field-treat certain raw food products 14 is illustrated in FIGS. 7 and 8. As set forth in these figures, most of the components of system 10 are the same and are generally configured as described above. In the preferred configuration of this embodiment, the system 10 is configured to be portable so it can be moved to or at least near the location where the food products 14 are being harvested. In the embodiment of FIG. 7, the conveyor apparatus 54 of the conveying mechanism 18 comprises a flat, mesh-like belt 64, which is preferably made out of stainless steel or the like, that has a plurality of spaced apart dividers 56, such as drag flats or the like, which define the product compartments 58 in which the raw food product 14 is received and the treating areas 92 in which the treated air 38 is applied to the raw food product 14 to produce the treated food product 22. Although FIG. 7, shows use of a product storage unit 46 and a feeder mechanism 48 to direct the food product 14 into the product compartments 58, those skilled in the art will readily appreciate that the system 10 is not limited to such uses. Instead, food product 14 may be placed into the various product compartments 58 by hand or by utilizing a field conveying machine. As with the system 10 described above, the treated air 38 enters the modular treatment unit 36 at the input manifold 68, passes through the input perforations 68 into the treating areas 92, treats the food product 14 and then exits through the exhaust perforations 74 to the exhaust manifold 72 and exhaust pipe 44, as best shown in FIG. 8. The operation of the system 10 is controlled by the controller 26. Any improperly or insufficiently treated food product 14/22 will be diverted by diverting mechanism 94 of the by-pass apparatus 24, usually to a diverter bin 96. As with use of the by-pass apparatus 24 in the processing system 28, the diverted food products are typically, but not exclusively, directed back to into system 10 to be re-treated therein. Alternatively, the diverted food products may be diverted to the diverter bin 96 and then disposed.

As described above, the system 10 of the present invention utilizes one or more modular treatment units 36 sealably connected together and/or to a tube 52 through which a conveyor apparatus 54 conveys raw food product 14 to apply treated air 38 from a treating apparatus 20 so as to produce treated food product 22. Presently, food treating systems typically treat raw food products 14 in the clean room 32 of a processing facility 28 or, with regard to field-processed food products 14, generally are able to accomplish no significant treating. The system 10 of the present invention allows the user to treat raw food products 14 so as to reduce the level of pathogens without causing any significant or any degradation with regard to treated food product 22. With regard to processing facilities 28, the system 10 of the present invention allows the user to easily, efficiently and effectively separate the treating of the raw food products 14 from the treated food products 22 to reduce the likelihood of any cross-contamination. With regard to field-processed food products 14, the system 10 of the present invention provides the user with the ability to safely, efficiently and effectively treat the food products 14 to achieve treated food products 22 that are significantly less likely to have pathogens associated therewith. As stated above, presently many field-packaged food products 14 are not treated, or are not significantly treated, for pathogens or to enhance the food product 14.

As will be readily appreciated by those skilled in the art, the exact configuration of the system 10, including the treating apparatus 20 and modular treatment unit 36 are highly dependent on the food products 14 to be treated and the desired type(s) of treatments to be performed to obtain the desired treated food product 22. In an example embodiment, two modular treatment units 36a and 36b are provided in approximately five foot lengths and the tube sections 66 thereof are sealably connected to tube 52 with a section of the tube 52 disposed between the two modular treatment units 36a/36b with the conveyor apparatus 54 moveably disposed through the tube 52 and the tube sections 66. The material selected for tube 52 and tube sections 66 can be of the double wall type or be otherwise configured to reduce loss of heat through the walls of the tube 52 and tube section 66. The size, configuration and placement of the input perforations 72 and the exhaust perforations 74 is selected to provide a desired flow rate at a certain pressure, typically depending on various characteristics of the raw food product 14 and the treatment that will be applied to the food product 14. These characteristics include the size of the food product 14, the amount of air flow that is required to cover the food products 14 in the treating area 92, the “fragility” of the food product 14 with regard to being damaged by the air flow rate, the speed of conveyance provided by conveyor apparatus 54 and the amount of treatment needed to obtain the desired pathogen reduction. In one example embodiment, the perforations 70/74 in the tube section 66, which can be a four inch diameter tube, can be approximately ⅛ inch diameter holes that are on ¼ inch centers and which extend for approximately thirty-six inches, with the offset spacing S being approximately six to ten inches on each side. If desired, multiple rows of input 70 and/or exhaust 74 perforations can be provided in the tube section 66. In one embodiment, the tube section 66 has more exhaust perforations 74 than input perforations 70 to ensure that there is sufficient open space for the exhaust air 40 to flow from the treating area 92 into the exhaust manifold 72 and exhaust pipe 44 without causing any back pressure. The input pipe 42 and exhaust pipe 44 can comprise two inch diameter tubes. In a preferred embodiment, both of the modular treatment units 36a/36b are configured the same to so as to be generally interchangeable with each other.

In one embodiment, the treating apparatus 20 for the above modular treating units 36a/36b comprises either a combined heating and chilling unit as the temperature adjusting mechanism 108 or two separate treating apparatuses 20 are utilized, one for each of the two modular treating units 36a/36b. In either embodiment, the heating unit portion of the treating apparatus 20 is placed in fluid flow communication with the first modular treating unit 36a and the chiller unit is placed in fluid flow communication with the second modular treating unit 36b. Hot and moist air is directed towards the food product 14 as it moves through the tube section 66 of the first modular treating unit 36a on the conveyor apparatus 54 to reduce pathogens to the desired level. Cool or cold air from the chiller is directed towards the treated food product 22 as it moves through the tube section 66 of the second modular treating unit 36b to lower the temperature of the treated food product 22 for ease of handling and packaging.

FIG. 10 summarizes a method 12 of treating a food product 14 to reduce the level of pathogens thereon and/or for enhancing the food product 14 so as to produce a treated food product 22. As set forth in FIG. 10, the method 12 generally comprises the steps of (1) placing the food product 14 in a product compartment 58 of conveying mechanism 18; (2) moving the food product 14 on a conveyor apparatus 54 through tube 52 of the conveying mechanism 18 that encloses the conveyor apparatus 54 therein; (3) directing treated air 38 from the treating apparatus 20 into the product compartment 58 through input perforations 70 in the tube section 66 to treat the food product 14 (e.g., by killing pathogens and/or enhancing food product 14) to achieve the desired treated food product 22; (4) flowing the exhaust air 40, either by suctioning with fan 124 or due to the pressure from fan 124, through the exhaust perforations 74 in tube section 66; (5) diverting the treated food product 22 as necessary if any portion thereof was not treated and/or was improperly treated; and (6) conveying the treated food product 22 for further processing and/or packaging. As set forth above, the step of directing treated air 38 into the product compartment 58 benefits from the offset spacing S of the perforations 70/74 effectively sealing the treating area(s) 92 to prevent contamination of the treated food product 22 from any untreated air, such as from the raw product room 30 of a processing facility 28. In such an embodiment, the treated food product 22 will be diverted out of the conveying mechanism 18 into a clean room 32 for sorting by a sorting apparatus 138 and/or other processing and packaging by the packaging apparatus 140. The treating apparatus 20 can be configured to direct hot or cool/cold treated air 38 to the tube section 66, which in a preferred embodiment is part of the modular treatment unit 36 portion of the conveying mechanism 18. As set forth above, prior to directing treated air 38 to the food product 14 in the product compartment 58 the treating apparatus 20 can also change the humidity/dew point of the air and/or add one or more pathogen removal chemicals and/or enhancing materials to the air to modify the characteristics of the treated food product 22. The product compartments 58 are defined between a pair of adjacent dividers 56 to provide a small treatment area 92 that allows for more effective control of the treatment of the food products 14. As shown in the drag line conveyor embodiment of FIGS. 3-6, the dividers 56 may be pucks or similarly configured objects. In the embodiment of FIGS. 7 and 8, the dividers 56 may be drag flats or the like.

The system 10 and method 12 of the present invention provides a number of benefits over existing and other prior art treating systems/methods for food products 14. One such benefit is the flexibility that is achieved for arranging treating systems by the use of the modular treatment unit 36. As will be readily appreciated by those skilled in the art, the modular treatment units 36 allow the user to quickly, easily and efficiently arrange and re-arrange the treating system 10 and method 12 to process different types of food products 14 or to produce different treated food products 22, all with significantly less capital than existing systems. Another advantage of the system 10 and method 12 of the present invention is that use of the relatively small space of the treatment area 92 allows the operator to more effectively and efficiently direct the treated air 38 to the raw food product 14 to achieve the desired level of pathogen reduction and/or enhancement of the food products 14. In addition, the small treating area 92 allows faster treatment at lower temperature and humidity levels than prior art systems, which results in less degradation of the food product 14 and resulting harm to the value of the treated food product 22. Another benefit of the system 10 and method 12 is the self-cleaning nature of the system 10, which results in significantly lower operating costs and less downtime than prior art treating systems. In addition, because the small treating area 92 provides more efficient and effective treating of the food product 14, the system 10 and method 12 of the present invention also reduces the cost of providing the hot or cool/cold air and/or enhancing materials to the food products 14 and the chemicals (if any) that are utilized to provide the desired level of pathogen reduction. By separating the handling and treating of the raw food products 14, which can now be entirely done in the raw product room 30, from the processing and packaging of the treated food product 22, which is done in the clean room 32, the system 10 and method 12 of the present invention significantly reduces the likelihood of any cross-contamination.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A system for treating a food product, comprising:
a conveying mechanism having an elongated tube and a conveyor apparatus, said tube defining a tube section, said conveyor apparatus moveably disposed through an interior of said tube section;
a product compartment conveyed by said conveyor apparatus through said interior of said tube section from a first end to a second end of said tube section;
means associated with said conveying mechanism for placing said food product into said product compartment prior to said product compartment entering said first end of said tube section;
a treating apparatus structured and arranged to discharge treated air to said tube section while said product compartment is in said tube section;
an input manifold attached to or integral with said tube section, said input manifold in fluid flow communication with said treating apparatus to receive said treated air from said treating apparatus and direct said treated air into said product compartment;
a plurality of input perforations disposed in said tube section at said input manifold, said input perforations sized and configured to allow said treated air to flow into said product compartment and treat said food product so as to produce a treated food product;
an exhaust manifold attached to or integral with said tube section; and
a plurality of exhaust perforations disposed in said tube section at said exhaust manifold, said exhaust perforations sized and configured to allow exhaust air to flow from said product compartment into said exhaust manifold.

2. The system of claim 1, wherein said placing means comprises a product storage unit and a feeder mechanism, said feeder mechanism structured and arranged to controllably feed said food product from said product storage unit into said product compartment.

3. The system of claim 1, wherein said product compartment is defined by said conveyor apparatus and one or more interior surfaces of said tube.

4. The system of claim 1, wherein said exhaust manifold is in fluid flow communication with said treating apparatus so as to direct said exhaust air to said treating apparatus.

5. The system of claim 1, wherein said input perforations and said exhaust perforations are respectively positioned so as to define an offset spacing selected to seal said treated air in a treating area defined by said product compartment.

6. The system of claim 1 further comprising a controller, said controller connected to at least one of said conveyor apparatus, said placing means and said treating apparatus.

7. The system of claim 1 further comprising a controller, said controller connected to each of said conveyor apparatus, said placing means and said treating apparatus.

8. The system of claim 1 further comprising a by-pass apparatus, said by-pass apparatus positioned after said second end of said tube section, said by-pass apparatus structured and arranged to divert said treated food products from said conveying mechanism.

9. The system of claim 1, wherein said treating apparatus comprises a duct configured to allow air to pass therethrough, a temperature adjusting mechanism configured to heat and/or cool the air and a fan configured to pressurize said air and direct said air to said input manifold.

10. The system of claim 9, wherein said treating apparatus further comprises a pressurized spray nozzle configured to spray fluid from a fluid supply into said duct so as to increase the humidity of the air.

11. A system for treating a food product, comprising:
a conveying mechanism having an elongated tube and a conveyor apparatus, said conveyor apparatus moveably disposed through said tube;
a product compartment conveyed by said conveyor apparatus through said tube;
a modular treatment unit having a tube section connected to said tube so as to receive said conveyor apparatus and said product compartment in an interior of said tube section, an input manifold attached to or integral with said tube section, a plurality of input perforations disposed in said tube section at said input manifold so as to place said input manifold in fluid flow communication with said interior, an exhaust manifold attached to or integral with said tube section and a plurality of exhaust perforations disposed in said tube section at said exhaust manifold so as to place said exhaust manifold in fluid flow communication with said interior of said tube section;
means associated with said conveying mechanism for placing said food product into said product compartment prior to said product compartment being received in said modular treatment unit;
a treating apparatus structured and arranged to discharge treated air to said tube section while said product compartment is in said tube section, said input manifold in fluid flow communication with said treating apparatus to receive said treated air from said treating apparatus and direct said treated air into said product compartment through said input perforations when said product compartment is positioned in said interior of said tube section so as to treat said food product in said product compartment to produce a treated food product, said exhaust perforations sized and configured to allow exhaust air to flow from said product compartment into said exhaust manifold; and
a controller connected to at least one of said conveyor apparatus, said placing means and said treating apparatus, said controller configured to monitor and/or control at least one of said conveyor apparatus, said placing means and said treating apparatus.

12. The system of claim 11, wherein said exhaust manifold is in fluid flow communication with said treating apparatus so as to direct said exhaust air to said treating apparatus, said treating apparatus configured to treat said exhaust air so as to produce said treated air.

13. The system of claim 11, wherein said controller is connected to and configured to monitor and/or control each of said conveyor apparatus, said placing means and said treating apparatus.

14. The system of claim 11 further comprising a by-pass apparatus, said by-pass apparatus positioned after said second end of said tube section, said by-pass apparatus structured and arranged to divert said treated food products from said conveying mechanism.

15. The system of claim 11, wherein said input perforations and said exhaust perforations are respectively positioned so as to define an offset spacing selected to seal said treated air in a treating area defined by said product compartment.

16. The system of claim 11, wherein said treating apparatus comprises a duct configured to allow air to pass therethrough, a temperature adjusting mechanism configured to heat and/or cool the air and a fan configured to pressurize said air and direct said air to said input manifold.

17. The system of claim 16, wherein said treating apparatus further comprises a pressurized spray nozzle configured to spray fluid from a fluid supply into said duct so as to increase the humidity of the air.

18. A method of treating a food product, said method comprising the steps of:
a) placing said food product in a product compartment of a conveying mechanism having an elongated tube and a conveyor apparatus moveably disposed through said tube;
b) moving the food product in said product compartment on said conveyor apparatus to a modular treatment unit having a tube section connected to said tube so as to receive said conveyor apparatus and said product compartment in said tube section;
c) directing treated air from a treating apparatus to said product compartment having said food product through a plurality of input perforations disposed in said tube section so as to treat said food product with said treated air and produce a treated food product;
d) flowing exhaust air from said product compartment through a plurality of exhaust perforations disposed in said tube section, the respective position of said input perforations and said exhaust perforations defining an offset spacing selected so as to seal said treated air in a treating area defined by said product compartment; and
e) conveying said treated food product for further processing and/or packaging.

19. The method of claim 18 further comprising the step of diverting said treated food product as necessary to prevent said treated food product from being contaminated by a pathogen before said conveying step.

20. The method of claim 18, wherein said directing step directs said treated air into an input manifold prior to said input perforations and said flowing step flows said exhaust air into an exhaust manifold after flowing through said exhaust perforations, each of said input manifold and said exhaust manifold sealably attached to or integral with said tube section.
